(19) United States
(12) Patent Application Publication
(10) Pub. No.: US 2013/0056582 A1
(43) Pub. Date: Mar. 7, 2013

(54) LANDING GEAR MOUNTED UNDER AN AIRCRAFT WING

(71) Applicants: Sébastien De Conto, Bretx (FR); Marc-Antoine Castanet, Plaisance-du-touch (FR)

(72) Inventors: Sébastien De Conto, Bretx (FR); Marc-Antoine Castanet, Plaisance-du-touch (FR)

(73) Assignee: AIRBUS OPERATIONS S.A.S., Toulouse (FR)

(21) Appl. No.: 13/698,204

(22) PCT Filed: May 16, 2011
(86) PCT No.: PCT/FR2011/051085

§ 371 Date: Nov. 15, 2012

(30) Foreign Application Priority Data
May 19, 2010 (FR) 1053885

(51) Int. Cl. B64C 25/10

(52) U.S. Cl. 244/102 A

(57) ABSTRACT

A landing gear mounted under an aircraft wing is provided. The aircraft can comprise a fuselage and wings each comprising at least one longitudinal spar connected to a wing box being part of the structure of the fuselage. The landing gear can comprise one leg that pivots, on its upper end, around a rotation axis to occupy at least one extended position and one retracted position and which is provided, on its lower end, with rolling means, the leg being connected, on its upper end, to the longitudinal spar of said wing. The landing gear can also comprise at least one inclined front strut connected, on its lower end, to said leg and connected, on its upper end, to the structure of the fuselage thru connecting means. The connecting means can comprise a sliding bearing crossed by at least one part of the upper end of said strut.

### CROSS-REFERENCE TO RELATED APPLICATION

This application is a U.S. National-Stage entry under 35 U.S.C.§371 based on International Application No. PCT/FR2011/051085, filed May 16, 2011, which was published under PCT Article 21(2) and which application claims priority to French Application No. 1053885, filed May 19, 2010, which are hereby incorporated by reference in their entirety.

### TECHNICAL FIELD

The technical field relates to a landing gear mounted under an aircraft wing, as well as an aircraft comprising, under each of the wings thereof, at least such a landing gear.

### BACKGROUND

It is known that the civil or military transport airplanes comprise one fuselage and two wings symmetrically arranged with respect to the latter. Each wing comprises one or more longitudinal spars connected with a wing spar box being part of the structure of said fuselage and under each of the wings a retractable landing gear is generally mounted, which may comprise one leg being adapted to pivot, on its upper end, around a rotation axis so as to occupy at least one extended position and one retracted position and which is provided with wheels on its lower end, said leg being connected, on its upper end, with a rear longitudinal spar of the wing. The landing gear may also comprise at least one inclined front strut connected, on its lower end, with said leg and, on its upper end, with said rear longitudinal spar thru a fitting.

It is further known that, in order to reduce the fuel mass of the modern airplanes, the latter can be provided with a canopy made of a composite material formed with superposed plies.

However, in flight, the wings are mainly subjected to an X-X axis bending moment parallel to the longitudinal axis of the airplane fuselage, resulting from the application of aerodynamic forces all over the surface thereof. Consequently, in order to resist such bending moment, the laminate of a composite material wing is mainly made of plies being oriented along a direction Y-Y being orthogonal to the axis X-X and corresponds to the privileged direction of said wing.

However, such orientation of the laminate may not be optimized to support the local efforts along another direction Z-Z being orthogonal, on the one side, to the axis X-X and, on the other side, to the axis Y-Y.

So, to take up the efforts generated by a landing gear of the above mentioned type, it is necessary to locally reinforce the wing structure by adding extra plies. Such a local reinforcement gets thinner when moving away from the effort application point along the axes Z-Z, X-X and Y-Y according to predefined decrease laws.

However, the connecting point between the front strut and the rear spar of the wing is too close to the wing box to be able to apply the above mentioned decrease laws. Consequently, such stiffness increase generates tensile and/or compressive efforts in the plane formed by the axes Y-Y and Z-Z and the structure close to said connecting point has to be dimensioned (for example by an increase of the thicknesses in the spar at the connecting point) so as to take up shearing efforts. This causes an undesirable mass increase.

Thus, it may be desirable to provide an improved landing gear mounted under an aircraft wing. In addition, other objects, desirable features and characteristics will become apparent from the subsequent summary and detailed description, and the appended claims, taken in conjunction with the accompanying drawings and this background.

### SUMMARY

According to one of various aspects of the present disclosure, a landing gear adapted to be mounted under an aircraft wing is provided. The aircraft can comprise a fuselage and wings each comprising at least one longitudinal spar connected to a wing box being part of the structure of said fuselage, and said landing gear can comprise one leg being adapted to pivot, on its upper end, around a rotation axis to occupy at least one extended position and one retracted position and which is provided, on its lower end, with rolling means, said leg being adapted to be connected, on its upper end, to said longitudinal spar of said wing. The landing gear can also comprise at least one inclined front strut connected, on its lower end, to said leg and adapted to be connected, on its upper end, to said structure of the fuselage thru connecting means. The connecting means can comprise a sliding bearing crossed by at least one part of the upper end of said strut.

Thus, in one exemplary embodiment, the upper end of the front strut is connected to the structure of the fuselage (and no longer to the canopy) in an area being already dimensioned to take up the efforts in the plane formed by the axes X-X and Z-Z. The reinforcement of the structure of the canopy of the airplane (including the dimensioning of the adjacent structures for taking up the local efforts from the strut) is no longer necessary, so that the corresponding undesirable mass increase is avoided.

It is to be noticed that the international application WO01/19672A1 describes a landing gear mounted under an aircraft wing, comprising a front strut connected, on its upper end, to the structure of the fuselage, thru connecting means under the form of fasteners. However, WO/19672A1 does not disclose any sliding bearing crossed by at least one part of the upper end of the strut.

Moreover, in one example, in the structure of said fuselage comprising a gear case adapted to receive said landing gear when it occupies the retracted position, said sliding bearing can be mounted on said gear case.

Furthermore, said connecting means generally comprises at least one fitting mounted on said wing box and to which the upper end of said strut crossing said sliding bearing is fastened.

In one example, the upper end of said strut comprises a trunnion adapted to cross, at least partially, said sliding bearing and to be fastened, on one of the ends thereof, to said fitting. Consequently, a sliding contact is carried out at the level of the sliding bearing, so that the tensile and/or compressive efforts generated by said front strut, along the direction Y-Y orthogonal to the longitudinal axis of the fuselage, are transferred onto the rear part of the wing box by the fitting fastened to the latter. Moreover, in the case of an aircraft, the wings of which are, at least partially, made of a composite material, the taking up of the efforts during the braking phases is performed by the wing box which is able to receive effort levels to be compared to what a gear strut can transmit, due to the fact that it is already dimensioned to support flight loads at least equivalent to the strut efforts.

Furthermore, the present disclosure also relates to an aircraft comprising, under each of the wings thereof, at least one landing gear such as above described.

Moreover, the aircraft comprising a fuselage and wings including each at least one longitudinal spar connected to a wing box being part of the structure of said fuselage, said spar is generally arranged in the rear part of said wing.

In addition, the wings of said aircraft are advantageously made of a composite material.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows, in a partial cutaway schematic top view, a current landing gear mounted under an aircraft wing.

FIG. 2 is a partial schematic view, in perspective, of the current landing gear of FIG. 1.

FIG. 3 shows, in a partially cutaway schematic top view, a landing gear according to the various teachings of the present disclosure being mounted under an aircraft wing.

FIG. 4 schematically represents the connecting means of the front strut of the landing gear of FIG. 3 with the structure of the aircraft fuselage according to the various teachings of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

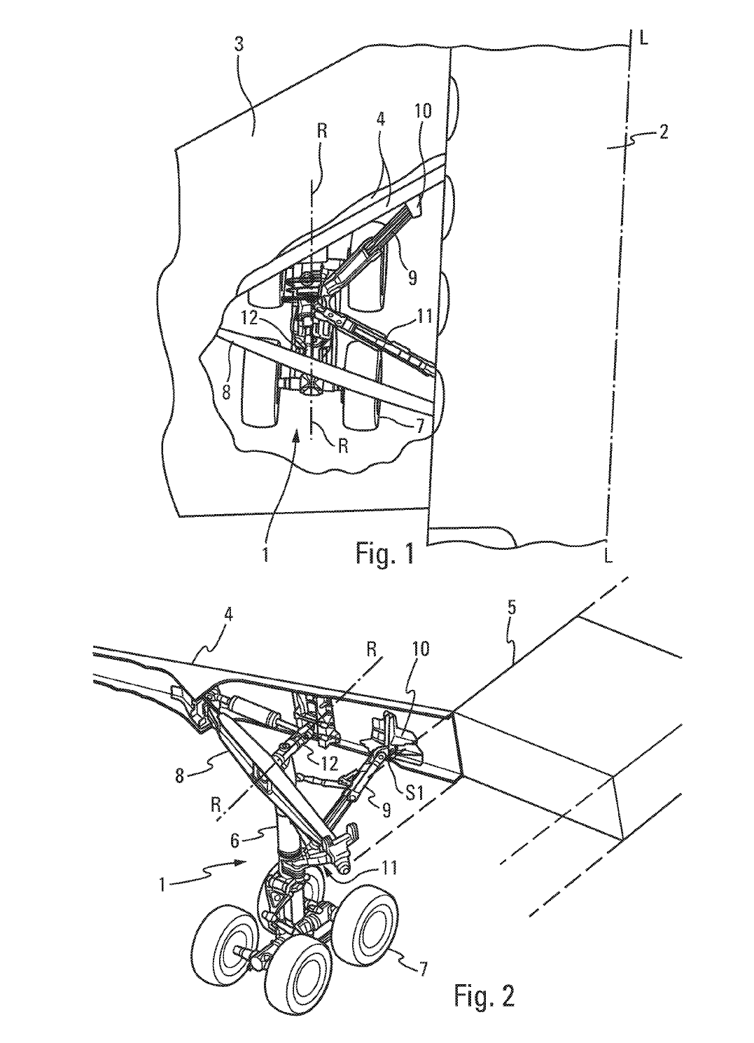

On FIGS. 1 and 2, a current landing gear 1 is represented, being mounted under a wing of a civil or military transport airplane. This airplane comprises one fuselage 2 and two wings 3 made of a composite material, for example with superposed plies mainly oriented along a direction Y-Y orthogonal to the longitudinal axis L-L of the fuselage 2.

Each wing 3 comprises several longitudinal spars 4, one of which is arranged in the rear part of the wing 3. The longitudinal spars 4 are connected to a wing bow 5 being integrally part of the structure of the fuselage 2.

In one example, the landing gear 1 may comprise one leg 6 being adapted to pivot, on its upper end, around a rotation axis R-R to occupy at least one extended position and one retracted position and which is provided with wheels 7 on its lower end, and one gear beam 8 connected, on one of the two ends thereof, to the rear longitudinal spar 4 and, on its other end, to the structure of the fuselage 2. The landing gear 1 may also comprise one inclined front strut 9 connected, on its lower end, to said leg 6 and, on its upper end, to the rear longitudinal spar 4 thru a fitting 10, and one inclined rear strut 11 connected, on its lower end, to the leg 6 of the gear 1 and, on its upper end, to the gear beam 8 at the level of the end of said beam 8 being connected to the structure of the fuselage 2.

Moreover, the upper end of the leg 6 comprises a rotation shaft 12, the longitudinal axis of which corresponds to the rotation axis R-R being substantially orthogonal to the longitudinal axis of the leg 6. Such shaft 12 is rotationally mounted, on one of its ends, on the rear longitudinal spar 4 and, on its other end, on the gear beam 8.

As indicated previously, due to the orientation in the main direction Y-Y of the plies of the composite material of the wings 3, the latter may not optimally support local efforts applied to the strut 9.

So, to take up the efforts of the landing gear 1, it is necessary to reinforce locally the structure of the wings 3 by adding extra plies. Such a local reinforcement gets thinner when moving away from the effort application point along the axes Z-Z, Y-Y and X-X according to predefined decrease laws.

However, the connecting point S1 between the front strut 9 and the rear spar 4 of one wing 3 is too close to the wing box 5 so that the optimal thickness can be reached. So, such stiffness increase generates tensile and/or compressive efforts in the plane formed by the axes Y-Y and Z-Z, so that the thicknesses of the structure adjacent to said point S1 have to be dimensioned to take up such effort increase. In one example, it is necessary to considerably increase the thicknesses of the rear longitudinal spar 4 at the vertical of the connecting point S1, thereby substantially increasing the total mass of the airplane.

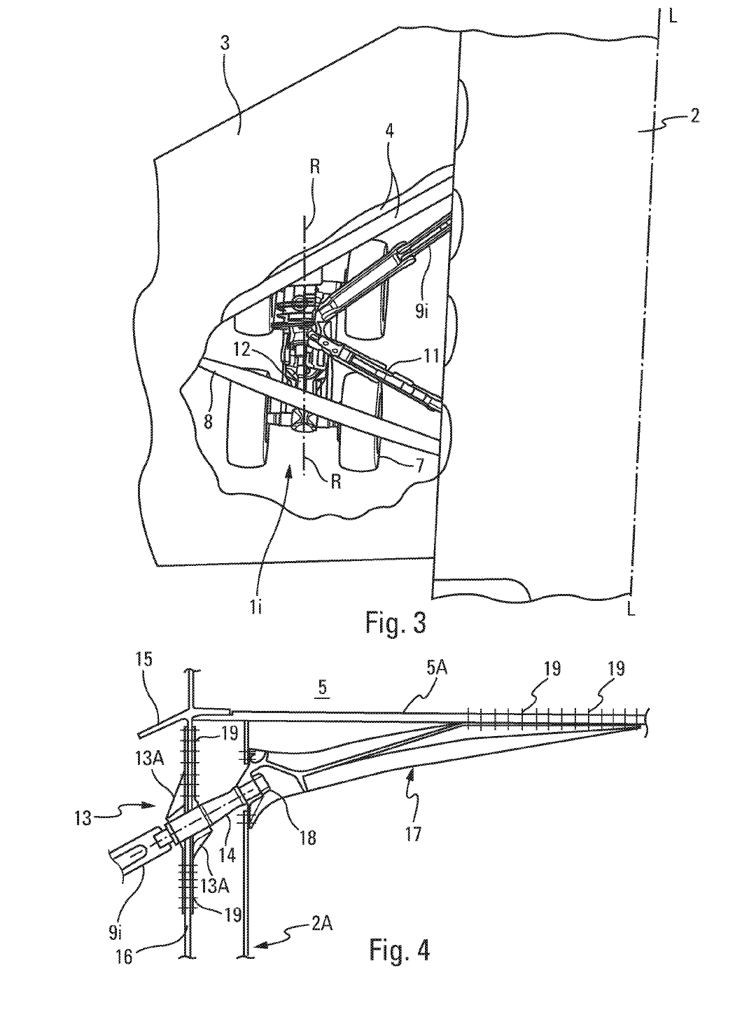

So, as shown on FIGS. 3 and 4, to reduce the efforts being exerted on the rear longitudinal spar 4 (and avoid an undesirable mass increase), the inclined front strut 9i of a landing gear 1i according to the various teachings of the present disclosure is connected thru connecting means 13 and 17 to the structure 2A, 16, 5A of the fuselage 2 and no longer to the rear longitudinal spar 4 of the wing 3 (the other elements of the landing gear 1i of the present disclosure being unchanged with respect to the landing gear 1 illustrated on FIGS. 1 and 2).

As represented on FIG. 4, the connecting means comprise one sliding bearing 13 in one or more parts, crossed by part of a trunnion 14 forming the upper end of the front strut 9i. The sliding bearing 13 is mounted, on the rear part of the rear vertical cross 15 of the wing box 5, on the gear case 16 adapted to receive the landing gear la when it occupies the retracted position and being part of the structure of the fuselage 2. In the example of FIG. 4, such sliding bearing 13 comprises two complementary parts 13A fastened on either side of part of the structure 2A of the fuselage 2. The connecting means can also comprise one fitting 17 mounted on the wing box 5 and to which the upper end of the front strut 9i (that is to say the end of the trunnion 14) is fastened, crossing the sliding bearing 13, for example, thru a nut 18.

So, a rotating sliding contact exists between the trunnion 14 of the front strut 9i and the sliding bearing 13 so that the tensile and/or compressive efforts generated by said front strut 9i, along the direction Y-Y, are transferred to the rear spar 5A of the wing box 5, thru the fitting 17 fastened to the latter.

Furthermore, FIG. 4 represents in a symbolic way by a line 19 each of the fastening means (for example, rivets) of the sliding bearing 13 to the structure of the fuselage 2 and those of the fitting 17 to the wing box 5.

It should be noticed that, due to the design of the present disclosure, the efforts exerted onto the gear beam 8 by the shaft 12 are also reduced, thereby allowing a reduction of the latter.

Furthermore, it is obvious that the teachings of the present disclosure also applies to airplanes, the wings of which would not be made of a composite material.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A landing gear for mounting under a wing of an aircraft, said aircraft including a fuselage and wings, each having at least one longitudinal spar connected to a wing box being part of the structure of said fuselage, and said landing gear comprising:
one leg pivotable, on its upper end, around a rotation axis to occupy at least one extended position and one retracted position and which is provided, on its lower end, with rolling means, said leg connectable, at its upper end, to said at least one longitudinal spar of a respective one of said wings; and
at least one inclined front strut connected, on its lower end, to said leg and connectable, on its upper end, to said structure of the fuselage thru connecting means,
wherein said connecting means includes a sliding bearing crossed by at least one part of the upper end of said strut.

2. The landing gear according to claim 1, further comprising a gear case coupled to the structure of the fuselage that receives said landing gear when it occupies the retracted position, and said sliding bearing is mounted on said gear case.

3. The landing gear according to claim 1, wherein said connecting means further comprises at least one fitting mounted on said wing box and to which the upper end of said strut crossing said sliding bearing is fastened.

4. The landing gear according to claim 3, wherein the upper end of said strut further comprises a trunnion that crosses, at least partially, said sliding bearing and is fastened, on one end, to said fitting.

5. An aircraft, comprising:
a fuselage having a wing box;
a plurality of wings, each of the plurality of wings having at least one longitudinal spar connected to the wing box; and
a landing gear positioned under each of the plurality of wings, the landing gear including:
one leg pivotable, on its upper end, around a rotation axis to occupy at least one extended position and one retracted position and which is provided, on its lower end, with rolling means, said leg connectable, at its upper end, to said at least one longitudinal spar of a respective one of the plurality of wings; and
at least one inclined front strut connected, on its lower end, to said leg and connectable, on its upper end, to said fuselage thru a sliding bearing crossed by at least one part of the upper end of said strut.

6. The aircraft according to claim 5,
wherein said at least one longitudinal spar is arranged in a rear part of each one of the plurality of wings.

7. The aircraft according to claim 5, wherein each one of the plurality of wings are made of a composite material.

8. The aircraft according to claim 5, further comprising a gear case coupled to the fuselage that receives said landing gear when it occupies the retracted position, and said sliding bearing is mounted on said gear case.

9. The aircraft according to claim 5, wherein said connecting means further comprises at least one fitting mounted on said wing box and to which the upper end of said strut crossing said sliding bearing is fastened.

10. The aircraft according to claim 5, wherein the upper end of said strut further comprises a trunnion that crosses, at least partially, said sliding bearing and is fastened, on one end, to said fitting.
